(19) United States
(12) Patent Application Publication
(10) Pub. No.: US 2010/0106344 A1
(43) Pub. Date: Apr. 29, 2010

(54) Unmanned land vehicle having universal interfaces for attachments and autonomous operation capabilities and method of operation thereof

(76) Inventors: Dean B. Edwards, Moscow, ID (US); John R. Canning, Moscow, ID (US)

Correspondence Address: Dean B. Edwards, 852 N. Grant, Moscow, ID, 83843, US

(21) Appl. No.: 12/290,040

(22) Filed: Oct. 27, 2008

(51) Int. Cl. G06F 19/00

(52) U.S. Cl. 701/2

(57) ABSTRACT

An apparatus and method is disclosed for a wireless remotely operable unmanned compact vehicle platform for use in land management comprising a frame and providing a pair of ground engageable endless drive tracks powered by a hydraulic fluid power source. The vehicle supports working attachments on the front end by utilizing a universal working attachment coupling interface carried on a pair of loader boom structures, and the vehicle supports working attachments on the rear end by utilizing a three point hitch apparatus. Working attachments coupled to the vehicle may be powered by the hydraulic fluid power source carried on the frame. A wireless remote control apparatus allows an operator to control the vehicle at a safe distance and a wireless video system allows an operator to control the vehicle accurately. A system of autonomous operation is integrated with the vehicle for travel in complex, unstructured environments. The claimed invention also utilizes a method of operation for the wirelessly operable unmanned vehicle control system which comprises a system wherein one or more mobile transmitters can be used to control one or more vehicles individually.

### CROSS-REFERENCE TO RELATED APPLICATIONS

The following patents are related to this invention: Remote Control Vehicle, Mark David Carter, U.S. Pat. No. 6,283,220; Vehicle Travel Route Control System, Masato Kageyama, U.S. Pat. No. 6,484,078; Robot Tractors, Timothy R. Pryor, U.S. Pat. No. 4,482,960; Method and Apparatus for Navigating a Remotely Guided Brush Cutting, Chipping and Clearing Apparatus, Donald B. Mullins, U.S. Pat. No. 6,044,316; Apparatus and Method for Wireless Remote Control of an Operation of a Work Vehicle, William L. Schubert & Abraham Orbach, U.S. Pat. No. 6,112,139; Multi-purpose Autonomous Vehicle with Path Plotting, Louis S. McTamaney et. al., U.S. Pat. No. 5,170,352; Method for the Video-assisted Remote Control of Machines, Especially Vehicles, and Device for the Implementation of this Method, Michel Bailly, U.S. Pat. No. 6,304,290; Tracked Compact Utility Loader, Joseph J. Walto et. al, U.S. Pat. No. 6,709,223; Remotely Operable Fire-fighting Vehicle, Edgardo Ham, U.S. Pat. No. 7,264,062.

### STATEMENT REGARDING FEDERALLY SPONSORED RESEARCH OR DEVELOPMENT

This invention was made with government support under grants 2003-33610-13077 and 2004-33610-15114 awarded by the United States Department of Agriculture. The government has certain rights in the invention.

### FIELD OF THE INVENTION

This invention relates to an unmanned compact land management vehicle platform which has a traction system and is guided remotely by an operator via a mobile wireless means and also has autonomous operation capabilities. Specifically, this invention relates to a tracked vehicle utilizing universal implement coupling interfaces in the front and rear, and said invention is adapted for use in a multitude of harsh environments.

### REFERENCE TO SEQUENCE LISTING, A TABLE, OR COMPUTER PROGRAM LISTING COMPACT DISC APPENDIX

Not Applicable

### BACKGROUND OF THE INVENTION

Forestry work vehicles have been built in many sizes for many dedicated functions. One important problem that many of these vehicles address is transporting timber or other materials from its location in the forest to a location where it can be loaded onto a transport vehicle or further processed, i.e. transporting timber from its fallen location. The state of the art is limiting in that currently available equipment is too costly for small timber operations. Most modern equipment also incorporates dedicated implements on the machine which limit the machine's versatility. These vehicles are also designed only to be controlled by an operator on board the equipment which requires Rollover Protective Structure/Falling Object Protective Structure (ROPS/FOPS) systems resulting in machines that are heavier and larger than would be required were human operators not on board the machine while in operation.

Forestry equipment of all sizes also are built as single-task machines. A one-task-one-machine design increases the cost to small forestry businesses, and for forestry tasks that require several pieces of equipment, may make it impossible to create a viable business plan. In addition, having several dedicated pieces of equipment requires additional training, labor, and other operation overhead costs. Using additional equipment also increases the environmental impact of logging operations.

Prior art indicates that small-scale utility vehicles have the capability to be remotely controlled. Small-scale vehicles are often preferable because their smaller size allows them to work in environments in which large-scale work vehicles cannot operate due to harsh conditions or because there is not enough open area within the environment for the larger machine to operate properly. Existing small-scale, low profile vehicles solve the problem of needing smaller vehicles to perform work in particular conditions; however, existing small-scale vehicles are not remotely controlled and therefore require the operator to manually control the vehicle or use a tethered control panel; either control option on existing vehicles require the operator to remain close to the vehicle which significantly increases the danger of injury to operator and limits the utility of existing vehicles to environments safe for human operators. Extravehicular operation does not allow for ROPS/FOPS systems which makes these types of vehicles unsuitable for use in dangerous environments. For example, a logging area may have trees tightly grown together or the ground may be too steep or uneven to allow the use of a large-scale vehicle; however, dangerously stacked fallen timber or uneven surfaces also make small-scale, manned vehicles unsuitable for many operations because the environment is too dangerous for the human operators which must work alongside the vehicle. In contrast, when using a remotely operated vehicle the human operator can be moved to a safe distance from the vehicle which still allows the vehicle to be used in dangerous areas. The claimed control system utilizes multiple video cameras which provide visual feedback to the operator's control device and allows the operator to control the vehicle from a safe location.

When an environment is too dangerous for human operators or for very simple transport needs, autonomous vehicles are often used. Vehicles programmed for autonomous control are most often used to carry material from one point to another within a fixed work area using onboard obstacle avoidance systems. MFC Corp. (U.S. Pat. No. 5,170,352, McTamaney et al., 1992) claims a vehicle that uses laser, sonic and optical sensors and is programmed to move between fixed and moving objects from point to point “over a most expedient route to a target.” Autonomous vehicles such as the one claimed by McTamaney are powered exclusively by electricity which limits their range due to the need for periodic charging. Due to the limitations of electric motors these electric vehicles are also unable to transport materials on rugged terrain.

In view of the foregoing background information, there is a need for small-scale, unmanned, remotely operable vehicles with systems that are powered by portable fuel. By removing the operator and controlling the system from a remote site, the forestry equipment can be made even smaller by obviating the need for a ROPS/FOPS safety system without increasing safety hazards for operators. These smaller pieces of equipment can be manufactured at significantly reduced cost and cause less environmental impact than their large-scale counterparts.

The claimed invention uses a hybrid system of autonomous and remote operator control. The autonomous programming allows the vehicle to self-control basic functions while the operator uses remote control equipment to control complex tasks. The claimed invention is also able to utilize petroleum-based fuels which eliminates the need for periodic charge and greatly extends the range of the vehicle. Functions of the claimed invention may be varied significantly by attaching or removing modular pieces of equipment. This vehicle does not follow a one-function-one-vehicle design and can be adapted with different tool attachments for use in many different functions (i.e. wildland fire management, snow removal, landscaping, military, power generation, pulling/pushing/cutting logs or brush, material transport, cultivation activities, and search and rescue) using readily available standard industrial equipment.

The claimed invention also utilizes a method of operation for the wirelessly operable unmanned vehicle control system which comprises a system wherein one or more mobile transmitters can be used to control one or more vehicles individually.

### BRIEF SUMMARY OF THE INVENTION

In view of the foregoing background, it's therefore an object of the present invention to provide a remotely operable unmanned compact vehicle platform for use in forestry, wildland fire, landscaping, snow removal, military, power generation, and the like. These and other objects, features, and advantages of the invention are provided by a tracked vehicle utilizing universal implement coupling interfaces in the front and rear, and that is guided remotely by an operator via a mobile wireless control system and/or an autonomous navigation system.

One embodiment of the invention relates to a wireless remotely operable unmanned compact vehicle platform for use in land management which comprises a frame. The frame provides structural strength, protection from debris, maintenance access, and attachment points for the contents therein. A source of power is carried on the frame. Left and right boom structures are pivotally attached to the top of two pair of vertical uprights at the rear of the frame and extend past the front end of the frame. A working attachment coupling structure is pivotally attached to the front ends of the pair of boom structures. At least one hydraulic actuating device connecting the pair of boom structures to the frame actuates the boom structures upwardly and downwardly about the pivot point on the frame and at least one hydraulic actuating device connecting the working attachment coupling structure to the pair of boom structures actuates the working attachment coupling structure in a sweeping motion about the pivot point on the front end of the pair of boom structures. A three point hitch device is carried on the rear end of the frame. A pair of lower lift arms of the three point hitch includes a means by which the lower lift arm lengths can be adjusted to accommodate a wide variety of working attachments. A traction system utilizing endless tracks, wheels with tires, or endless tracks entrained about wheels with tires, is carried on the frame and accelerates the vehicle in forward and reverse directions. At least one hydraulic fluid power source is actuated by the source of power and provides power to the traction system, hydraulic actuating means on the pair of boom structures on the front end, hydraulic actuating means on the three point hitch on the rear end, and auxiliary hydraulic actuating means for working attachments releasably coupled to the front working attachment coupling structure or the rear three point hitch.

The second embodiment of the invention relates to a wireless remotely operable unmanned compact vehicle platform for use in land management which comprises a means for remotely operating the vehicle during operating conditions. A mobile transmitter with a plurality of input means produces a wireless signal corresponding to the actuation by the operator of one or more input means. A receiver carried on the frame of the vehicle receives the signal from the transmitter through a receiver antenna and a control circuit receives the signal from the receiver antenna. The control circuit transmits a corresponding signal to an electronically actuated hydraulic valve block carried on the frame. The hydraulic valve block controls the flow of hydraulic fluid to the intended hydraulically actuated device carried on the frame and the desired device is actuated corresponding to the operator input.

The third embodiment of the invention relates to a wireless remotely operable unmanned compact vehicle platform for use in land management which comprises a video transmission means for remotely viewing images surrounding the worksite such that an operator can monitor the worksite from a remote location. A plurality of cameras carried on the frame are arranged to provide a sufficient, unobstructed view of the worksite during specific operating conditions of the vehicle. Each camera is equipped with a wireless signal transmitting means. One or more viewable monitors are carried on the mobile transmitter operated by the operator whereby the operator's view of the worksite is supplemented by the video transmission means and is therefore removed from hazards.

The fourth embodiment of the invention relates to a wireless remotely operable unmanned compact vehicle platform for use in land management which comprises a means for autonomous navigation of the vehicle through unstructured environments. The processes on the vehicle are driven by embedded processors in a wired Ethernet backbone whereby certain processors are dedicated to certain tasks and communicate over the network. Inertial sensors, a global positioning system, ultrasonic sensors, stereo cameras, and a magnetometer are monitored by the onboard processors. The inputs of the sensors are combined in a fuzzy logic hierarchical controller to fuse all the sensor data and provide and estimate of vehicle position. The vehicle mapping system receives signals from the stereo cameras and the acoustic range sensor array to produce a range map of the terrain surface used to produce a three-dimensional map for vehicle movement planning.

The fifth embodiment of the invention relates to a method of operation for a wireless remotely operable unmanned compact vehicle platform for use in land management which comprises a system wherein one or more mobile transmitters can be used to control one or more vehicles individually.

### BRIEF DESCRIPTION OF THE SEVERAL VIEWS OF THE DRAWING

FIG. 1 is a perspective view of a wireless remotely operable unmanned compact vehicle, in accordance with the present invention;

FIG. 2 is a side view of the vehicle shown in FIG. 1;

FIG. 3 is a block diagram of the vehicle shown in FIG. 1;

FIG. 4 is a top view of the transmitter unit;

FIG. 5 is a block diagram for the autonomous control structure;

FIG. 6 is a block diagram of the single vehicle with two operators method; and

FIG. 7 is a block diagram of the multiple operators and multiple vehicles control method.

### DETAILED DESCRIPTION OF THE INVENTION

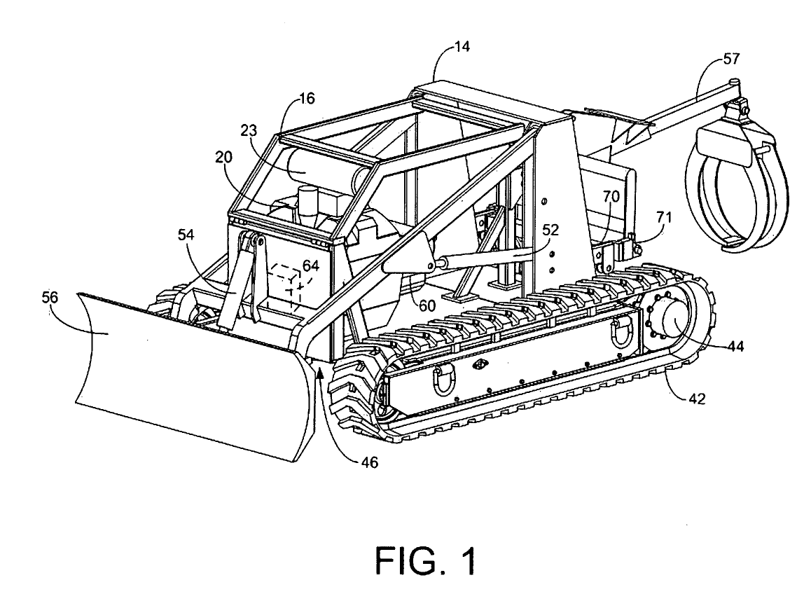

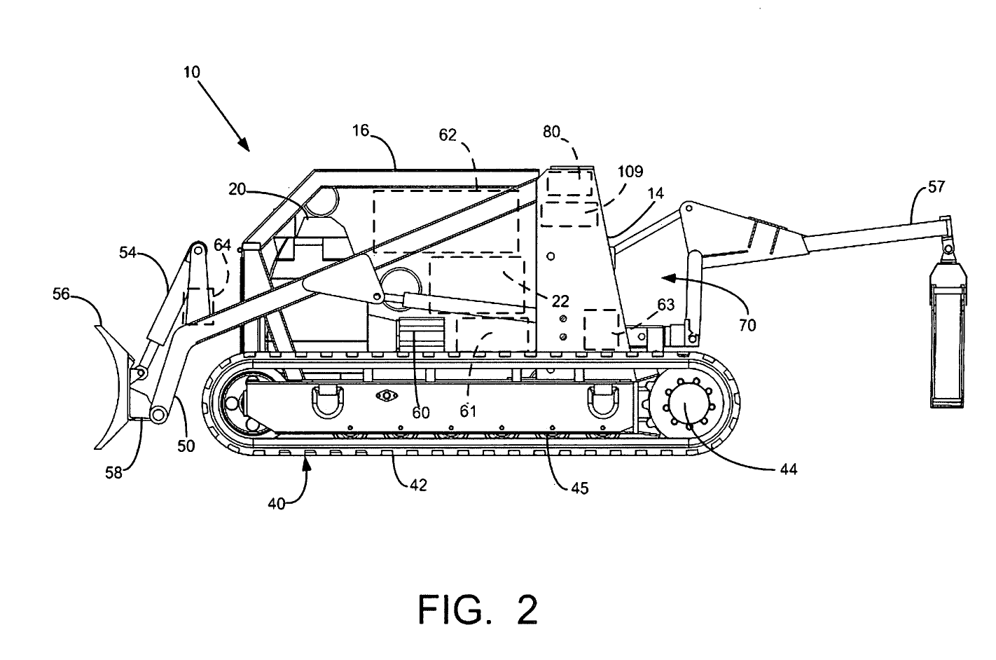

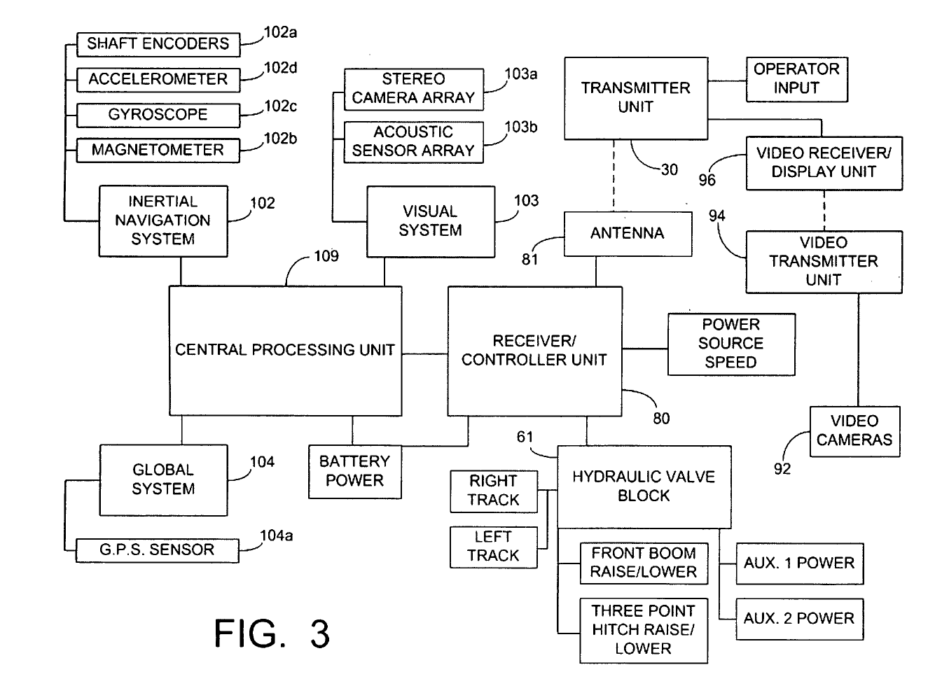

This invention relates to a wireless remotely operable unmanned compact vehicle platform for use in land management. The apparatus of this invention is referred to generally in FIGS. 1-7. More particularly, one embodiment of this invention relates to a remotely operable unmanned compact vehicle platform for use in land management comprising the vehicle represented by the numeral 10 (See FIG. 2).

Vehicle 10 can be used by homeowners, commercial entities specializing in land management, and government entities specializing in land management. Vehicle 10 includes attachment points for working attachments on the front and rear ends of the vehicle. For example, a log grapple can be attached to the three point hitch on the rear of vehicle 10 and a blade can be attached to the miniature skid steer type attachment coupler 58 on the front of vehicle whereby the vehicle becomes a tree skidding and fuels reduction machine. It should be understood, however, that vehicle 10 can be configured with many different working tool attachments to solve problems in forestry, wildland fire, landscaping, snow removal, military, and power generation applications, and should not be limited to land management.

Referring to FIGS. 1-3, vehicle 10 includes a frame 12 on which a power source 20 is carried. Power source 20 may be an internal combustion engine using diesel, gasoline, propane, biodiesel, ethanol, methanol, or the like carried in fuel tank 22, or the power source may be electric (not shown) with a battery pack (not shown) replacing fuel tank 22. Hood structure 16 covers the frame 12 and protects the contents therein. Hood structure 16 is composed of steel tubing that is adequate in strength to deflect large debris, such as trees or large rocks, from damaging the apparatus carried on frame 12, and expanded steel or sheet metal interconnects the steel tubing frame of hood structure 16 whereby small debris, such as branches, may not damage the apparatus carried on frame 12.

Central support structure 14 is defined by two pair of upright, laterally spaced members, two on the left side of frame 12 and two on the right side. The spacing between each respective pair of uprights and the distance between the two pair corresponds to the width of each member of loader boom structure 50 and the distance between each boom, respectively. A horizontal plate that spans the width of the four upright members and is welded to each member to provide lateral strength and rollover protection, as well as a mounting point for necessary hardware. Boom 50 is pivotally attached on the left and right side to the top portion of the left and right pair of uprights of central support 14 and the free end of boom 50 extends past the front of the vehicle. At least one hydraulic cylinder 52 is connected to central support 14 and boom 50 and actuates said boom 50 up and down about central support 14. A working attachment coupler 58 is pivotally attached to the end of boom structure 50 and is actuated forwardly and rearwardly with respect to boom structure 50 by hydraulic actuator 54.

Working attachment coupler 58 allows for the quick attachment and detachment of working attachment 56. Working attachment coupler 58 may be one of many popular quick attachment designs, such as the BOB-TACH system (as shown). A multi-use blade is shown as working attachment 56, and it should be understood, however, that a large variety of working attachments such as an auger, backhoe, bucket, bucket with grapple, cement bowl, breaker, pallet forks, ground preparation equipment, snow blower, angled brush, stump grinder, trencher, vibratory plow, borer, brush cutter, and the like are available for use interchangeably with working attachment coupler 58 along with a multi-use blade 56.

Three point hitch apparatus 70 is a variation of a universal three point hitch mechanism found on many tractors whereby lower lift arm 71 is pivotally attached to the lower portion of central support 14 and is restricted from lateral movement as it rotates about a bearing (not shown) at central support 14 and is actuated upward and downward by hydraulic rocker shaft apparatus 73 with respect to the pivotal attachment at central support 14. Typical agricultural three point hitch mechanisms utilize lower lift arms that are attached to the frame with a ball joint means whereby the lower lift arm has three degrees of freedom (or where it can tip, tilt, and rotate) allowing for the distance between the free ends of the lower lift arms to be adjusted to accept an implement. This method allows for some lateral sway of the lower lift arms, and therefore the working attachment, despite the use of tensioners to restrict sway. The method chosen for the current invention utilizes the Quick Hitch standard set forth by the American Society of Agricultural Engineers (ASAE) wherein the lower lift arm coupler 74 has a left and a right attachment means whereby the distance between them corresponds to ASAE Quick Hitch standards. This method restricts lateral movement while allowing a working attachment 57 to be connected to three point hitch apparatus 70 in between the pair of tracks 40 and allowing substantial clearance.

A log grapple is shown as working attachment 57, and it should be understood, however, that three point hitch apparatus 70 may couple to a large variety of working attachments including, but not limited to, a mower deck, brush cutter, flail mower, box blade, auger, rototiller, tine rake, angle blade, disc harrow, power take-off (PTO) generator, PTO log splitter, and the like are available for use interchangeably with three point hitch apparatus 70 along with a log grapple.

Traction system 40 is comprised of track set 41 and track set 42 which are rigidly attached to frame 12 by traction system frame 46. Track set 41 and 42 utilize endless drive tracks made of rubber or metal and are entrained in the front by an idler wheel and tensioning device, a hydraulic drive motor unit 44, and bogey wheels 45. Hydraulic fluid power is supplied to traction system 40 by hydraulic pump 60 and hydraulic valve block 61. Two hydraulic drive motor units 44, one each on track set 41 and track set 42, actuate the endless drive tracks independently in forward or reverse directions. Traction system 40 may comprise of four wheels (not shown) covered with endless tracks (not shown) that would be actuated by hydraulic pump 60 and hydraulic valve block 61 similarly to the actuation of track set 41 and 42, and, additionally, traction system 40 may comprise of four wheels actuated by a similar method.

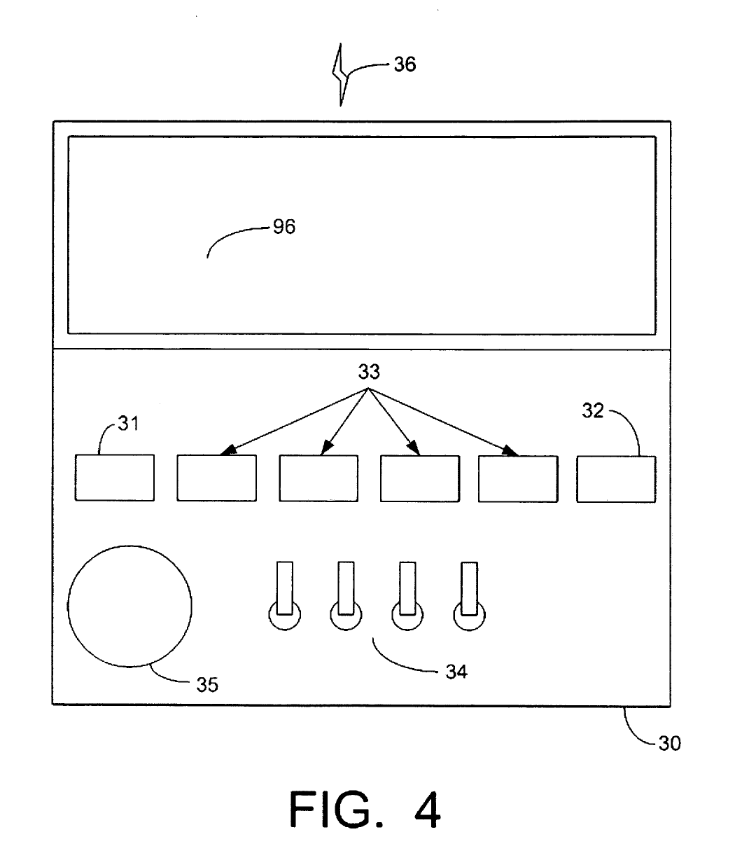

Referring to FIG. 4, the unmanned vehicle 10 is controlled wirelessly by transmitter 30, which utilizes a control interface, such as the “paddle” style of levers 31-33, to accept an input from operator 1. Levers 31 and 32 may be analog controls whereby an output signal varies with the corresponding operator input and levers 31 and 32 may ultimately control the actuation of traction system 40. Levers 32 control auxiliary functions such as front and/or rear working attachment hydraulic controls, throttle position, the raising and lowering of three point hitch apparatus 70, the raising and lowering of loader boom structure 50, the tilting of working attachment coupler 58, PTO unit 76, a hydraulic winch (not shown), and the like. Levers 32 in the current invention utilize at least four inputs, although more or less auxiliary function inputs may be used depending on the application. Levers 32 may be analog controls or digital on/off controls depending on the precision of movement required for auxiliary functions supported by vehicle 10. Levers 31-33 may be of any alternate design that ultimately converts operator inputs into accurate control signals. Toggle switches 34 are on/off controls for ignition, vehicle 10 power, vehicle 10 autonomy modes, or mode toggles for transmitter 30 controlling multiple vehicles. A large red push button 35 is an emergency stop button that cuts power to all vehicle 10 system electronics.

Transmitter 30 utilizes a battery power source and onboard microprocessor-based units that convert operator inputs to corresponding radio signals that are transmitted by an internal antenna. The radio signals are received by antenna 81, carried on vehicle 10, and corresponding electrical signals are relayed to receiver 80. Receiver 80 utilizes a processing means to process and analyze the signals received by the antenna and determine those which were sent by transmitter 30. The signals transmitted by transmitter 30 are specifically coded for use with receiver 80. Additionally, receiver 80 is a control unit whereby output terminals are connected by wire to electromechanical devices carried on vehicle 10. More specifically, receiver 80 sends analog and/or digital control signals to electrically-actuated valves mounted in hydraulic valve block 61, in addition to sending analog and/or digital control signals to power source 20 ignition system, power source 20 throttle position actuator (not shown), and a system power relay (not shown).

A hydraulic system carried on frame 12 is powered by power source 20 and transmits hydraulic power to all hydraulic devices, both permanently carried on frame 12 and releasably coupled to frame 12 through working attachment coupler 58 and three point hitch apparatus 70. A source of fluid power, hydraulic pump 60, is coupled to the output shaft of power source 20. The variable displacement hydraulic pump 60 utilizes an axial piston design with a swash plate as a displacement control means. However, the hydraulic system may utilize one of many types of hydraulic fluid power means. Hydraulic pump 60 is connected by hydraulic hose to hydraulic valve block 61, wherein a series of electrically actuated spool valves are mounted. The valves in hydraulic valve block 61 may regulate fluid flow proportionally or may function digitally on/off, or zero and full flow modes only.

Working attachments 56 and 57 may require fluid power to properly operate hydraulic cylinders or motors integrated into each respective attachment. For example, a log grapple as working attachment 57 on three point hitch apparatus 70 will require hydraulic power to actuate the jaws of the grapple, and a brush mower as working attachment 56 releasably attached to coupling plate 58 will require hydraulic power to operate a hydraulic motor that rotates a brush cutting device. In such a case, four outputs from hydraulic valve block 61 are required to fully operate auxiliary equipment: one pressure line to the brush cutter, one pressure line to hydraulic cylinders 52 for raising and lowering, one pressure line to the grapple, and one pressure line to hydraulic rocker shaft apparatus 73 for raising and lowering. However, the example configuration may not be optimal for the operator when presented with an alternate application than that which a log grapple and brush mower can be utilized. Quick disconnect hose fittings are popular means for connecting and disconnecting hydraulic hoses between releasably coupled hydraulic devices and machinery. Quick disconnect fittings use a one-way valve to block hydraulic flow when a compliment fitting is not connected, and, conversely, allow full flow when the hydraulic lines of a device are connected. Hose connect points 63 on the rear end and 64 on loader boom structure 50 consist of two pairs each of hose quick disconnect points, two pressurized lines and two return to tank 62 lines on both ends of vehicle 10. This configuration allows, for example, a dozer blade as working attachment 56 and a log grapple as working attachment 57 with the addition of a hydraulic winch (not shown) mounted onto the log grapple. A fixed or manually-adjustable dozer blade doesn't require any hydraulic power, other than that to raise the device, which is provided to loader boom structure 50. The devices on the rear end of the vehicle, however, require three pressurized lines; one line is used for lifting, another for the grapple jaws, and the third for the hydraulic winch. In this case, pressure and return lines from the grapple and the winch are connected to hose connect point 63. In this way multiple configurations of hydraulic devices may be operated remotely.

Video transmission system 90 is comprised of at least one wireless camera 92 in the front of vehicle 10, at least one wireless camera 94 in the rear of vehicle 10, a transmitting means (which may be integrated into cameras 92 and 94), and a receiving and display means 96 attached to wireless transmitter 30. Video transmission system 90 may utilize one of many Federal Communications Commission (FCC) approved data transmission frequencies. For example, the current embodiment may use IEEE 802.11b or 802.11g wireless communication standards for transmission at 2.4 GHz up to 200 yards outdoors. Cameras 92 and 94 transmit streaming video data on different channels. Receiver and display 96 utilizes a directional antenna (not shown) that detects the 802.11b/g wireless signal transmitted by cameras 92 and 94 and displays a chosen video channel, corresponding to the specific camera the operator may want to utilize, and includes a means by which the operator may switch camera channels. Receiver and display 96 may utilize a “screen in screen” feature whereby the display shows a primary video channel at full size with secondary and possibly tertiary channels shown as scaled windows within the screen. The primary and lesser video channels may be chosen by operator 1. The “screen in screen” feature allows the operator to view with greatest detail a primary video channel of interest while monitoring others with less detail. Another variation of display screen 96 usage would be multiple windows with similar aspects whereby operator 1 may monitor all video channels at one time.

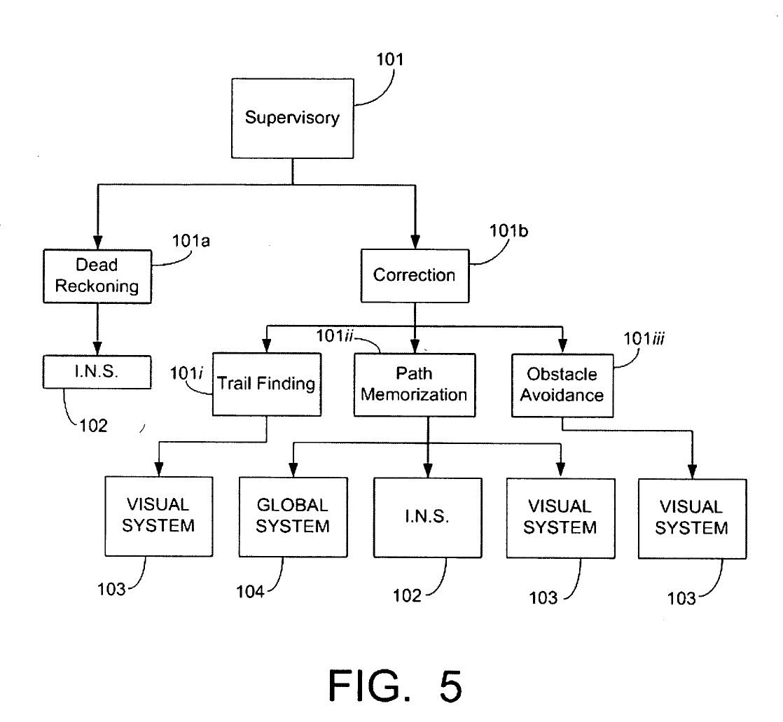

Referring to FIG. 5, autonomous system 100 utilizes a “navigate and correct” control structure 101 to guide vehicle 10 independently of the wireless remote control system. Navigate and correct control structure 101 utilizes a memorizing and learning autonomy interface whereby an operator manually navigates vehicle 10 from an initial point to a desired destination and vehicle 10 may replicate the path. Control structure 101 utilizes a path correction system that mitigates differences in the initially navigated path, such as changes in position of obstacles or new obstacles, and as such vehicle 10 can navigate a path from point to point under varying conditions. Autonomous system 100 is controlled by embedded processors in a micro-controller board 108 mounted within central processing unit (CPU) 109 carried on vehicle 10.

The main supervisory function of control structure 101 is divided into a dead reckoning function 101a and a correction function 101b. Dead reckoning function 101a utilizes inertial system 102 to make an estimate of the position of vehicle 10 based solely on the total movement of the vehicle. Inertial system 102 sensors consist of shaft encoders 102a, magnetometer 102b, gyroscope 102c, and accelerometer 102d. The estimated position of vehicle 10 calculated by dead reckoning function 101a is compared to the data of correction function 101b.

Correction function 101b is further broken down to trail finding function 1011, path memorization function 101ii, and obstacle avoidance function 101iii. Trail finding function 101i utilizes visual system 103 to create a 3D map of the terrain approaching the vehicle. Visual system 103 consists of stereo camera set 103a and acoustic range sensor array 103b. Stereo camera set 103a has at least two “bumblebee” style cameras, the images of these cameras are mixed in microcontroller 108 to create a 3D map of the terrain in front of vehicle 10. Acoustic range sensor array 103b contains a lower array of three sensors and an upper array of three sensors. The lower array directs ultrasonic signals to the immediate terrain in front of vehicle 10 and the upper array directs ultrasonic signals further in front of the vehicle. Signals reflected from objects are collected and calculated to determine if vehicle 10 is following an appropriate path. Similarly, obstacle avoidance function 101iii utilizes the same two arrays of acoustic sensors whereby the lower sensor collects diffracted signals from irregularities on the approaching ground, and the upper array is directed at a further distance in front of the vehicle. Collected signals are filtered and categorized into hazardous or safe obstacles, and the controls system acts accordingly if objects must be avoided. The path memorization function 101ii utilizes inertial system 102, visual system 103, as well as global system 104. Global system 104 utilizes a Global Positioning System (GPS) 104a to track and record the position of vehicle 10. Recording data from the three autonomous sensor systems allows the vehicle to utilize specific data when replicating a path of travel.

The current invention, as outlined by the above mentioned systems, describes a remotely operable unmanned compact vehicle platform for use in land management with high productivity and greatly increased safety implementations. The removal of an operator on board the vehicle eliminates the high cost and large size requirements of ROPS/FOPS systems, yielding a less expensive, more space-efficient vehicle with a lower center of gravity, higher power-to-weight ratio, and complete removal of the operator from job site hazards. Additionally, removing the operator from the vehicle allows the operator to multitask and one vehicle to be dedicated to multiple operators.

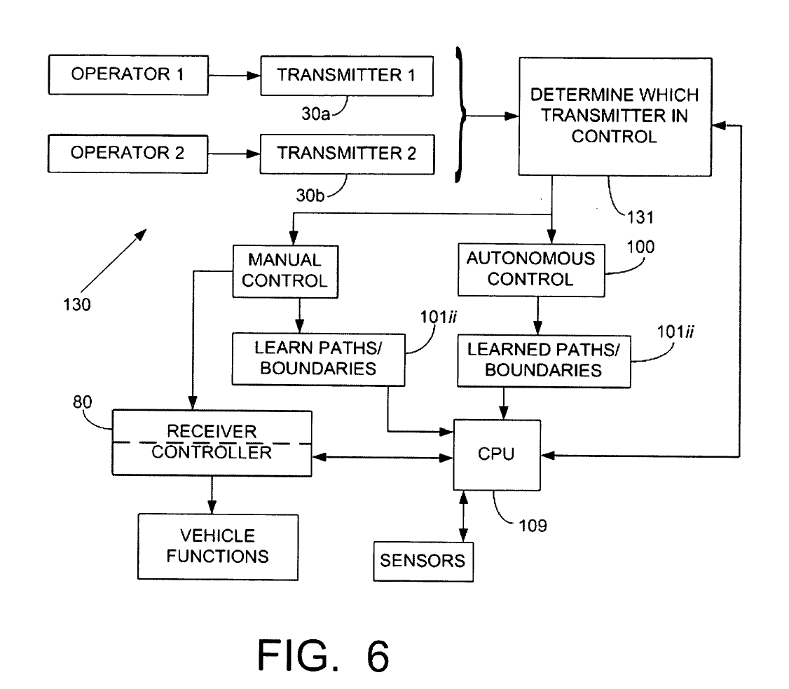

One method of operation utilizes two operators and one vehicle with a “time share” system of remote control. Referring to FIG. 6, control method 130 utilizes two operators with remote control transmitters, both utilizing one vehicle 10. Transmitters 30a and 30b communicate with CPU 109 through receiver unit 80 and determine from operator input which transmitter is in control of vehicle 10. Control block 131 represents the device identification system used between the CPU 109, receiver 80, and transmitters 30a and 30b that determines the state of control for transmitters 30a and 30b, with the resultant information displayed to the operator through the video display screen 96 on transmitters 30a and 30b. The respective operator in control may choose to manually remotely control vehicle 10 or may choose to engage autonomous system 100. Prior to engaging autonomous system 100 the respective operator in control of vehicle 10 must initiate the path memorization function 101ii for the vehicle to learn paths or area boundaries, as previously described. Control method 130 allows operators to multitask and utilize vehicle 10 autonomously for operations that distract an operator from more demanding tasks. For example, an operator in a selective logging application may fell trees, exchange the chainsaw for the remote control transmitter 30a to grapple a log with vehicle 10, then control vehicle 10 down a path with the timber payload. When vehicle 10 is nearing the range limit of remote control transmitter 30a, the operator chooses to initiate autonomous mode 100 with transmitter 30a, allowing vehicle 10 to guide itself to the landing site from where it began. A second operator at the landing chooses to obtain control of vehicle 10 with remote control transmitter 30b and controls vehicle 10 to the log deck, releases the payload, and engages the autonomous mode 100 again to control vehicle 10 back to the first operator at the felling operation. In this way, the first operator may continue felling trees, topping, or limbing until vehicle 10 arrives again, and the second operator may organize, scale, or load the logs at the landing site. It should be understood, however, that this process should not be limited to logging and could be used for many alternate applications in forestry, wildland fire, landscaping, snow removal, military, and the like.

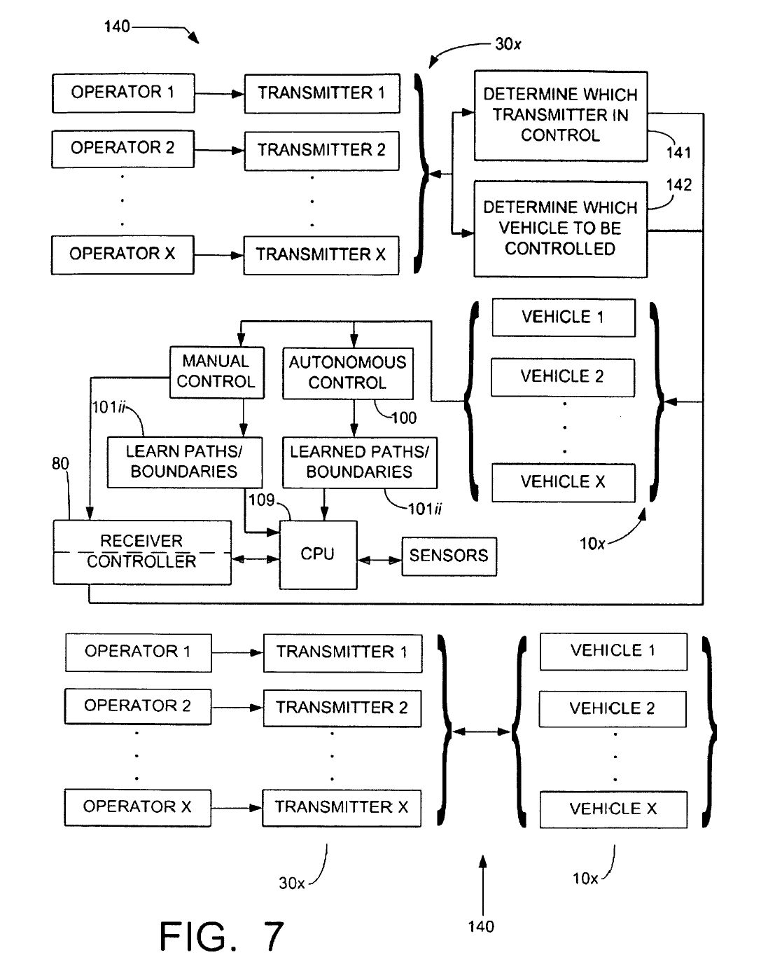

A second method of operation utilizes a plurality of vehicles and operators in a network of vehicles moving material from job site to job site. Referring to FIGS. 6 and 7, control method 140 utilizes multiple operators with remote control transmitters 30x, utilizing multiple vehicles 10x. Transmitters 30x communicate with CPUs 109 on each individual vehicle 10x through receiver units 80 and determine from operator input which transmitter 30x is in control of vehicle 10x. Control block 131 represents the device identification system used between the CPUs 109, receivers 80, and transmitters 30x that determines the state of control for transmitters 30x, with the resultant information displayed to the operator through the video display screens 96 on transmitters 30x. Video display screen 96 may display, in addition to video images, a status monitor (not shown) and vehicle proximity monitor (not shown) indicate which vehicles are near or are being controlled by the respective operator. The respective operator in control may choose to manually remotely control vehicle 10x or may choose to engage autonomous system 100. Prior to engaging autonomous system 100 the respective operator in control of vehicle 10x must initiate the path memorization function 101ii for the vehicle to learn paths or area boundaries. Control method 140 allows operators to multitask and utilize multiple vehicles 10x autonomously for operations that distract an operator from more demanding tasks, and, additionally, allows for multiple vehicles to be utilized autonomously in complex, unstructured environments. As a safety feature, if more than one operator attempt to control one vehicle at a time, the vehicle will stall until the issue is resolved between operators.

A third method of operation utilizes a plurality of vehicles and operators wherein individual vehicles employ specialized implement combinations to perform different tasks within a job site. This heterogeneous mixture of vehicles allows for one or more operators to manually control the appropriate vehicles when necessary and to engage the autonomous mode of each respective vehicle. Control method 140 in FIG. 7, as mentioned above, is adequate to describe the control method for heterogeneous vehicles. The use of a heterogeneous grouping of vehicles can be used in applications requiring more than one type of task to be completed. For example, a vehicle that is fitted with a dozer blade on the front end and a log grapple on the rear end can be used for normal log skidding operations. A vehicle fitted with a brush cutter on the front end and a tine rake on the rear end can be used for brush abatement and removal. This combination of vehicles can work together to perform all of the functions required for fuels reduction in fire danger zones. It should be understood, however, that any number of combinations of vehicles may be used to satisfy the requirements of many job sites.

1. A remote operating system consisting essentially of:
(a) a vehicle to be controlled;
(b) a network of embedded processors carried on said vehicle for sensing and control tasks;
(c) multiple sensors including Global Position System (GPS), Inertial Navigation System (INS), compasses for magnetic direction, and an acoustic range sensing array;
(d) a proximity detecting device utilizing a sensor carried by the operator and a sensing device carried on said vehicle whereby said power source is disabled when operator arrives at a predetermined proximity from said vehicle.
(e) optical dual stereo short baseline cameras;
(f) multiple video cameras carried on said vehicle;
(g) a high performance embedded processor for vision computing;
(h) a signal transmission and receiving system for wirelessly transferring images captured by cameras to said remote control;
(i) an autonomous navigation system for navigational control and hazard avoidance of said vehicle through unstructured environments using a computer-based control scheme with sensors for acoustic ranging, inertial and global position, and stereo ranging;
(j) a remote control receiving and transmitting apparatus onboard and powered by said vehicle with the ability to receive and transmit wireless control signals at various individually coded signals, said receiver having the ability to receive and process signals from a plurality of portable remote control transmitters thereby providing related signals to system electronics apparatus;
(k) said remote control signal receiver provides corresponding signals to respective elements on the vehicle, including but not limited to a hydraulic valve block, ignition switch, navigation systems, and emergency safety shutoff device;
(l) a “local” and “remote” function state of computerized controller units carried on said vehicle that is controllable by said mobile remote control transmitter apparatus and determines the state of said vehicle when transitioning between a remotely controlled “remote” state and an autonomous “local” state or a hybrid combination thereof where basic navigation of the vehicle is “local” and control of complex vehicle operations remains “remote.”
(m) a hand-operable and portable remote control transmitter that receives input commands from an operator and visual data transmitted from said video cameras and wirelessly transmits data signals correlating to input commands;
(n) a system for receiving images from said video cameras and displaying images to an operator wherein the image receiving and displaying unit may be carried on said remote control transmitter or may be a separate, portable unit.
(o) a status indicator on said remote control signal receiver indicating the identification of vehicles within proximity of any given operator and the state of control the operator may have over any vehicle;

2. A wireless remotely operable unmanned vehicle platform comprising:
(a) The remote operating system of claim 1;
(b) an unmanned frame;
(c) a power source in connection with the frame;
(d) a traction system in connection with the frame for propelling said vehicle;
(e) working attachment interfaces in connection with the frame on the front end and the rear end;
(f) a hydraulic power system.

3. The vehicle of claim 2, wherein said frame comprises:
(a) a central support structure wherein a pair on the left side and a pair on the right side of laterally spaced uprights are joined by a horizontal plate rigidly attached on top of the uprights further improving the strength and durability of said central support structure thereby providing rollover protection for said vehicle;
(b) a protective hood or shroud in connection with said central support structure;
(c) a traction system in connection with said frame;
(d) a pair of boom structures pivotally attached to upper end of said central support structure on the left end and right end, respectively, with each respective free end of said pair of booms extending beyond the front of said frame; and
(e) a three point hitch mechanism mounted to said central support.

4. The vehicle of claim 2, wherein said traction system comprises:
(a) left and right endless drive tracks carried on the frame, wherein each track is actuated independently by said hydraulic source to propel said frame in forward and reverse directions;
(b) left and right endless drive tracks each actuated independently by its own separate drive motor;
(c) said proportional control device wherein each track is controlled by a hydraulic valve, said valves receiving separate signals relayed from said receiver, and each valve having the ability to control hydraulic fluid flow in substantially infinite increments from zero flow to a maximum flow;
(d) four wheels, one pair on the left side of said vehicle and one pair on the right side of said vehicle whereby each pair of wheels are actuated independently by their own drive motor;
(e) four wheels, one pair on the left side of said vehicle and one pair on the right side of said vehicle wherein each pair of wheels may drive endless, removable tracks.

5. The vehicle of claim 2, wherein a working attachment interface on the front end of said vehicle comprises:
(a) a pair of boom structures pivotally secured to the upper end of the left and right sides of said central support structure, respectively, whereby each free end of said pair of booms extending beyond the front end of said rigid frame;
(b) a left and right hydraulic actuator pivotally connected at one end to said central support structure at the left end and right end, respectively, and at the opposite end pivotally connected to said left and right boom structures, respectively, whereby said hydraulic actuator actuates said boom structure pair upwardly and downwardly;
(c) a universal working attachment coupling interface pivotally attached to free end of said pair of boom structures, with a hydraulic actuator pivotally connected at one end to said boom structure and at the opposite end pivotally connected to said working attachment coupling interface whereby said working attachment coupling interface is actuated in a substantially sweeping motion relative to said boom structures;
(d) a universal working attachment coupling interface that can be coupled to plurality of working attachments including, but not limited to: a dozer blade, auger, backhoe, bucket, bucket with grapple, cement bowl, breaker, pallet forks, ground preparation equipment, snow blower, angled brush sweeper, stump grinder, trencher, vibratory plow, borer, brush cutter, and the like.

6. The vehicle of claim 2, wherein a three point hitch working attachment interface on the rear end of said vehicle comprises:
(a) left and right lower lift arms that are pivotally attached to said central support structure at one end and extend past the rear end of said rigid frame;
(b) a working attachment that is pivotally attached to the end of the left and the right lower lift arm, respectively, that is opposite the frame, with an attachment device whereby the working attachment is movable upwardly and downwardly and is laterally fixed respective to said rigid frame;
(c) said lower lift arms adjustable in length;
(d) a three point hitch working attachment interface that can be coupled to a plurality of working attachments including, but not limited to: mower deck, brush cutter, flail mower, box blade, auger, rototiller, tine rake, angle blade, disc harrow, power take-off generator, power take-off log splitter, and the like.

7. The vehicle of claim 2, wherein a hydraulic power system carried on the frame comprises:
(a) a hydraulic fluid pump for providing hydraulic fluid power to hydraulic devices on said vehicle that is actuated by said power source;
(b) a hydraulic valve block and accompanying hydraulic hoses and fittings for distributing fluid power in correspondence with the input of an operator.

8. The vehicle of claim 2, specifically modified for use in land management, said vehicle comprising:
(a) multiple hydraulic hoses connected at one end of each hose to said hydraulic valve block and at the free end of each hose connected to a coupling device wherein each free end of the individual hydraulic hoses may be connected to a complimentary coupling device interface on said working attachments whereby fluid energy is transferred from said vehicle to said working attachment;
(b) multiple hydraulic hoses that may be coupled to said working attachment on the front end, or the back end, or a device carried on the frame such as a winch or power take-off, or any combination thereof;
(c) working attachment releasable couplers carried on the frame on the front end and the rear end of said vehicle;
(d) said pair of boom structures carried on the front of the vehicle coupled to said working attachments appropriate to said front working attachment coupler;
(e) said three point hitch apparatus carried on the rear of the vehicle coupled to said working attachments appropriate to said three point hitch;
(f) a hydraulic power source powering said working attachments.

9. The vehicle of claims 2 through 8, specifically modified for use in remote areas, wherein said power source comprises:
(a) an engine combustion system utilizing fuel selected from a group of at least one of a: diesel, gasoline, propane, biodiesel, ethanol, methanol, or the like, whereby a tank for storage of the appropriate fuel is carried on said vehicle.

10. A method of operation for a wireless remotely operable unmanned vehicle platform for use in land management, said method comprising a shared control of said vehicle through the use of said means in claim 1 for remotely operating the vehicle by one operator at one location and another operator at another location wherein one operator maintains control of the operations of the vehicle within a designated proximity of control and, as the vehicle approaches the subjective operating proximity of another operator, the second operator may obtain control of the vehicle.

11. A method of operation for a wireless remotely operable unmanned vehicle platform for use in land management, said method comprising a shared control of a plurality of said vehicles through the use of said means for remotely operating the vehicle by one or more operators within each operator's respective proximity of control, said method comprising:
(a) The remote operating system of claim 1;
(b) a status indicator indicating the identification of vehicles within proximity of any given operator and the state of control the operator may have over any vehicle;
(c) A mount enabling the remote operating system device to be carried on an all terrain vehicle whereby an operator may operate said unmanned vehicle using said mounted remote operating system while riding on said all terrain vehicle with minimal fatigue.

12. A method of operation for a wireless remotely operable unmanned vehicle platform for use in land management, said method comprising a heterogeneous group of two or more vehicles comprising:
(a) individual vehicles carrying working attachment configurations whereby each respective vehicle is optimized for different specialized functions within a job site;
(b) multiple vehicles utilizing specific respective working attachment configurations to perform multiple functions within a job site;
(c) one or more operators controlling the functions of each respective vehicle through said system for remote operation of claim 1;
(d) one or more operators utilizing said autonomous system of claim 1 on said vehicles when appropriate.
